(19) United States
(12) Patent Application Publication
(10) Pub. No.: US 2022/0150594 A1
(43) Pub. Date: May 12, 2022

(54) METHOD FOR MESSAGE INTERACTION, TERMINAL AND STORAGE MEDIUM

(71) Applicant: BEIJING DAJIA INTERNET INFORMATION TECHNOLOGY CO., LTD., Beijing (CN)

(72) Inventors: Pengyan YAO, Beijing (CN); Miao TONG, Beijing (CN); Yuan WANG, Beijing (CN); Haibo XU, Beijing (CN); Junhong LI, Beijing (CN); Qihao LIU, Beijing (CN)

(21) Appl. No.: 17/522,597

(22) Filed: Nov. 9, 2021

(30) Foreign Application Priority Data
Nov. 10, 2020 (CN) 202011247869.8

(51) Int. Cl. H04N 21/4788; H04N 21/431; H04N 21/435

(52) U.S. Cl. CPC H04N 21/4788; H04N 21/435; H04N 21/4312

(57) ABSTRACT

Provided is a method for message interaction, including: displaying a live-streaming page of a live-streaming room, wherein a message interaction control is displayed on the live-streaming page, the message interaction control being configured to perform message interaction with a first message processing client, and the first message processing client being an auxiliary client corresponding to an anchor client; acquiring a first interaction message as input in response to the message interaction control being in an activated state; and sending the first interaction message to the first message processing client in response to a message sending instruction on the first interaction message, wherein the first message processing client is configured to process the first interaction message.

The present application is based on and claims priority to Chinese Patent Application No. 202011247869.8, filed on Nov. 10, 2020, the disclosure of which is herein incorporated by reference in its entirety.

### TECHNICAL FIELD

The present disclosure relates to the field of internet technologies, and in particular, relates to a method for message interaction, and a terminal.

### BACKGROUND

At present, the interaction between anchors and audiences can be supported during a video live-streaming process. For example, an anchor of a live-streaming room can interact with the audience by browsing messages sent by the audience in a comment region.

### SUMMARY

The present disclosure provides a method for message interaction, and a terminal. The technical solutions of the present disclosure are as follows.

According to an aspect of embodiments of the present disclosure, a method for message interaction is provided. The method is applicable to an audience client, and includes:

displaying a live-streaming page of a live-streaming room, wherein a message interaction control is displayed on the live-streaming page, the message interaction control being configured to perform message interaction with a first message processing client, the first message processing client being an auxiliary client corresponding to an anchor client; acquiring a first interaction message as input in response to the message interaction control being in an activated state; and sending the first interaction message to the first message processing client in response to a message sending instruction on the first interaction message, wherein the first message processing client is configured to process the first interaction message.

According to another aspect of e embodiments of the display disclosure, a terminal is provided. The terminal includes:

a processor; and a memory configured to store at least one instruction executable by, the processor,

wherein processor, when loading and executing the at least one instruction, is caused to perform:

displaying a live-streaming page of a live-streaming room, wherein a message interaction control is displayed on the live-streaming page, the message interaction control being configured to perform message interaction with a first message processing client, and the first message processing unit being an auxiliary client corresponding to an anchor client;

acquiring a first interaction message as input in response to the message interaction control being in an activated state; and

sending the first interaction message to the first message processing client in response to a message sending instruction on the first interaction message, wherein the first message processing client is configured to process the first interaction message.

According to another aspect of the embodiments of the display disclosure, a non-transitory storage medium storing at least one instruction therein is provided, wherein the at least one instruction, when loaded and executed by a processor of a terminal, causes the terminal to perform:

displaying a live-streaming page of a live-streaming room, wherein a message interaction control is displayed on the live-streaming page, the message interaction control being configured to perform message interaction with a first message processing client, and the first message processing client being an auxiliary client corresponding to an anchor client;

acquiring a first interaction message as input in response to the message interaction control being in an activated state; and

sending the first interaction message to the first message processing client in response to a message sending instruction on the first interaction message, wherein the first message processing client is configured to process the first interaction message.

### BRIEF DESCRIPTION OF THE DRAWINGS

The accompanying drawings, which are incorporated in and constitute a part of this description, illustrate the embodiments consistent with the present disclosure and, together with the description, serve to explain the principles of the present disclosure, and do not constitute an improper limitation of the present disclosure.

FIG. 1 is an application environment diagram of a method for message interaction according to some embodiments.

FIG. 2 is a flowchart of a method for message interaction according to some embodiments.

FIG. 3 is a schematic diagram of displaying a second interaction message according to some embodiments.

FIG. 4 is a schematic diagram of displaying a third interaction message acquired by aggregation according to some embodiments.

FIG. 5 is a schematic diagram of a message processing page displayed by a second message processing client according to some embodiments.

FIG. 6 is a schematic diagram of displaying a second interaction message according to some embodiments.

FIG. 7 is a schematic diagram of displaying a second interaction message according to some embodiments.

FIG. 8 is a schematic diagram showing a session page of an audience client and second message processing client according to some embodiments.

FIG. 9 is a flowchart, of a method for message interaction according to some embodiments of the present disclosure.

FIG. 10 is a flowchart of a method for message interaction according to some embodiments of the present disclosure.

FIG. 11 is a block diagram of an apparatus for message interaction according to some embodiments.

FIG. 12 is an internal structure diagram of a terminal according to some embodiments of the present disclosure.

### DETAILED DESCRIPTION

To make those of ordinary skill in the art understand the technical solutions of the present disclosure better, the technical solutions in the embodiments of the present disclosure are clearly and completely described in the following with reference to the accompanying drawings.

It is to be noted that terms “first,” “second,” and the like in the description and claims, as well as the above accompanying drawings, of the present disclosure are used for the purpose of distinguishing similar objects instead of indicating a particular order or sequence. It should be understood that the terms used in this way can be interchanged under appropriate circumstances, such that the embodiments of the present disclosure described herein can be implemented in an order other than the order illustrated or described herein. The implementations set forth in the following description of the exemplary embodiments do not represent all implementations consistent with the present disclosure. Instead, they are merely examples of apparatuses and methods consistent with aspects related to the present disclosure as recited in the appended claims.

Currently, the messages sent by an audience in a live-streaming room are directly sent and displayed in a preset comment region on a page of the live-streaming room. Since a large number of messages are displayed in a comment region, some important messages are easily overlooked and missed by an anchor as the messages are constantly refreshed. Especially for a live-streaming room with lots of audiences, such as an e-commerce live-streaming room, due to the huge volume of audience messages and a high refresh rate, it is likely that the anchor fails to notice and reply to some important.

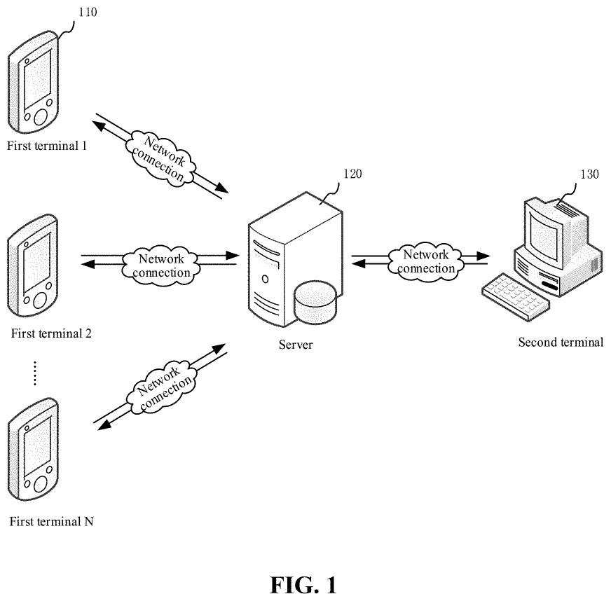

A method for message interaction according to the present disclosure is applicable to an application environment shown in FIG. 1. Here, at least one audience client 110 communicates with a server 120 over a network; and a first message processing client 130 communicates with the server 120 over the network. The audience client 110 is a user terminal for the audience, or a user account for logging in a live-streaming application in a user terminal, or the like, wherein the live-streaming application can be configured to watch live streaming. The first message processing client 130 is a user terminal used by a message processing person, or a user account for logging in a message processing application in the user terminal, or the like, wherein the message processing application can process messages, and is an auxiliary application of the live-streaming application. A live-streaming page of a live-streaming room is displayed at the audience client 110, and a message interaction control is displayed on the live-streaming page. In a case that the audience wants to provide a message required to be responded to and the message interaction control is in an activated state, a first interaction message is input by the audience client 110, is sent to the server 120 by the audience client 110, and is sent to the first message processing client 130 by the server 120. After receiving the first interaction message, the first message processing client 130 processes the first interaction message. Here, the above user terminal includes, but is not limited to, various personal computers, notebook computers, smart phones and tablet computers. The server 120 may be an independent server or a server cluster composed of a plurality of servers.

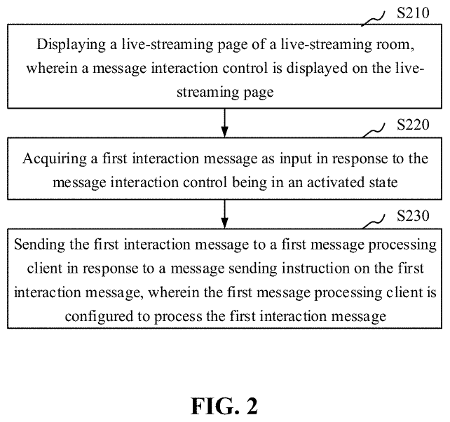

FIG. 2 is a flowchart of a method for message interaction according to some embodiments. As shown in FIG. 2, the method for message interaction is applicable to the audience client 110 and includes the following steps.

In S210, a live-streaming page of a live-streaming room is displayed, wherein a message interaction control is displayed on the live-streaming page.

Here, the live-streaming page is a live-streaming video picture of an anchor, such as a live-streaming page in any one of scenes such as e-commerce live-streaming and game live-streaming. The anchor triggers a creation request of the live-streaming room by an anchor client. The anchor client creates the live-streaming room in response to the creation request, and generates the live-streaming page by collecting live-streaming video streams in real time.

The message interaction control is an object that sends an interaction message to the first message processing client. That is, the message interaction control is configured to perform message interaction with the first message processing client. The first message processing client is an auxiliary client corresponding to a live-streaming client. The message interaction control includes, but is not limited to, being displayed on the live-streaming page in a form of a fixed control, or in a form of a floating button, or the like. In addition, the message interaction control is displayed at any position on a live-streaming interface.

In some embodiments, the audience client enters the live-streaming room by searching, hot spot recommendation, etc. The audience client receives the live-streaming video streams sent by the server in real time, and displays the live-streaming page of the live-streaming room. The message interaction control, pre-deployed on the live-streaming interface, is displayed on the live-streaming page.

In S220, a first interaction message as input is acquired in response to the message interaction control being in an activated state.

Here, the message interaction control in the activated state means that the audience client can perform message interaction with the first message processing client. The first interaction message refers to a message that the audience wants a live-streaming party to respond to, and is not limited to one or a combination of a text, speech, an image, a link, a video, etc.

In some embodiments, in a case that the audience wants to send the first interaction message and the message interaction control is in the activated state, the first interaction message is input by the audience client; and the audience client acquires the first interaction message.

In S230, the first interaction message is sent to the first message processing client in response to a message sending instruction on the first interaction message, wherein the first message processing client is configured to process the first interaction message.

Here, the first message processing client is an auxiliary side corresponding to the anchor client, and is managed by other people (hereinafter referred to a message processing person) except the anchor during the live-streaming. The first message processing client, the audience client, and the anchor client are in a same system, and data interaction between every two clients is realized by the server in the system.

In some embodiments, after the audience completes editing the first interaction message, a message sending instruction is triggered by the audience client. In the case that the message interaction control is in the activated state, the audience client sends the first interaction message to the server in response to the message sending instruction, and the server sends the first interaction message to the first message processing client, such that the first message processing client can process the first interaction message.

In some embodiments, the server further sends the first interaction message to the anchor client, such that the anchor can know the needs of the audience in time.

In some embodiments, in a case that the message interaction control is in an inactivated state, after acquiring the first interaction message, the audience client sends the first interaction message to the server in response to the message sending instruction, and the server sends the first interaction message to the anchor client and the audience client in the live-streaming room, such that the anchor can interact with the audience based on the first interaction message.

In the above method for message interaction, the live-streaming page of the live-streaming room is displayed when the audience watches a live-streaming video of the anchor, wherein the message interaction control is displayed on the live-streaming page; the first interaction message as input is acquired in the case that the message interaction control is in the activated state; and the first interaction message is sent to the first message processing client in response to a message sending instruction on the first interaction message, wherein the first message processing client is configured to process the first interaction message. On the one hand, by providing the message interaction control to the audience client, the audience can send messages that require responses from the live-streaming party to the first message processing client according to needs, such that the audience messages can be processed in time, and the processing efficiency of the audience messages is improved, thereby facilitating the improvement of an interaction effect in the live-streaming room, and help lengthening the time of the audience in watching live-streaming. On the other hand, by providing the first message processing client to process the audience messages by other people, the anchor does not need to pay too much attention to the messages sent by the audience during the live-streaming process, which is helpful to improve the quality of the live-streaming.

In some embodiments, prior to S220 of acquiring the input first interaction message in response to the message interaction control being in the activated state, the method further includes: changing the message interaction control from the inactivated state to the activated state in response to a trigger operation on the message interaction control.

In some embodiments, an initial state of the message interaction control is the inactivated state. By triggering the message interaction control by the audience, the audience client is instructed to change the message interaction control from the inactivated state to the activated state. The message interaction control can also be changed from the activated state to the inactivated state. Accordingly, by triggering the message interaction control again by the audience, the audience client is instructed to change the message interaction control from the activated state to the inactivated state.

In the embodiments of the present disclosure, the audience can adjust the state of the message interaction control and freely select a message processing path according to their own needs, such that the messages can be flexibly processed.

In some embodiments, after S230 of sending the first interaction message to the first message processing client, the method further includes: receiving a second interaction message acquired by processing the first interaction message by the first message processing client; and displaying the second interaction message on the live-streaming page.

Here, the second interaction message includes, but is not limited to, one or a combination of a text, speech, an image, a link, a video, etc.

In some embodiments, in the case that the message interaction control is in the activated state, after receiving the first interaction message sent from the audience client, the server sends the first interaction message to the first message processing client. After receiving the first interaction message, the first message processing client displays the first interaction message on a message processing page. The messages on the message processing page are displayed in a form of a session list. For example, a plurality of first interaction messages from the same audience client is displayed in an aggregated fashion, or is displayed in a form of a message list. For another example, the first interaction messages from different audience clients are displayed in a tiled fashion based on a time sequence of the received first interaction messages.

They ways for the first message processing client to process the first interaction message include but are not limited to reply and forward. The first message processing client acquires the second interaction message by processing the first interaction message based on the acquired message processing method, and sends the second interaction message to the audience client by the server, such that the audience client can display the second interaction message on the current live-streaming page.

According to the embodiments of the present disclosure, by providing a channel capable of focusing on processing audience messages, the audience messages can be processed in time, such that the processing efficiency of the audience messages is improved, thereby facilitating the improvement of an interactive effect in the live-streaming room, and help lengthening the time of the audience in watching live-streaming.

In some embodiments, displaying the second interaction message on the live-streaming page includes: displaying the second interaction message on the live-streaming page according to a first message displaying style, wherein the first message displaying style is different from a second message displaying style. The second message displaying style corresponds to an interaction message at the live-streaming client.

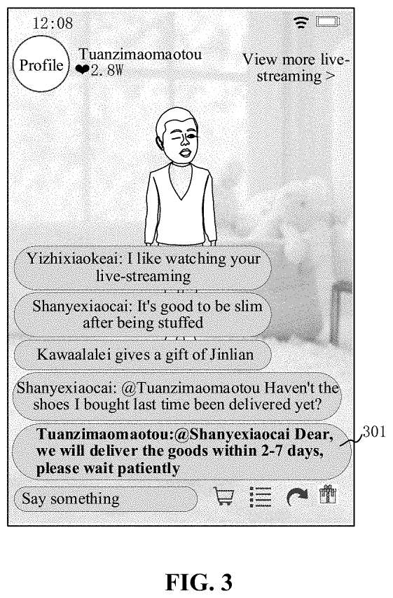

Here, the first message displaying style includes, but is not limited to, a font, color (for example, yellow) and the like of the displayed message. The first message displaying style is pre-configured in the audience client. In some embodiments, after receiving the second interaction message, the audience client acquires the pre-configured first message displaying style, renders the second interaction message according to the first message displaying style, and displays the second interaction message as rendered on the current live-streaming page. It can be understood that the first message displaying style is different from the second message displaying style, and the second message displaying style corresponds to the interaction message at the live-streaming client. Therefore, a message displaying style of the second interaction message is different from displaying styles of other messages on the live-streaming page, such that the audience can quickly read the second interaction message. FIG. 3 exemplarily shows a schematic diagram of a second interaction message displayed by the audience client. As shown in FIG. 3, the second interaction message 301 is displayed on the live-streaming page in a bold font style.

In the embodiments of the present disclosure, by displaying the second interaction message differently with respect to other messages, it is convenient for the audience to quickly recognize and read a reply message for the first interaction message, thereby improving the message interaction efficiency.

In some embodiments, displaying the second interaction message on the live-streaming page includes: displaying the second interaction message at a preset position on the live-streaming page, wherein a displaying duration of the second interaction message is a preset duration.

Here, the preset position is any position on the live-streaming page. For example, the preset position is at the top or bottom of all messages. Continuing to refer to FIG. 3, the preset position is at the bottom of all the messages, and the second interaction message 301 is fixedly displayed at the bottom of all the messages. In some embodiments, the displaying position and the displaying duration of the second interaction message are pre-configured. After the audience client receives the second interaction message, the second interaction message is displayed at the preset position. The audience client acquires the displaying duration of the second interaction message in real time; and the display of the second interaction message is canceled after the displaying duration reaches the preset duration. The displaying duration is any duration, such as 2 seconds.

According to the embodiments of the present disclosure, by displaying the second interaction message at a fixed position, the second interaction message does not move along with the refresh of other messages on the live-streaming interface, which is convenient for the audience to find the second interaction message. By configuring the displaying duration of the second interaction message, on the one hand, the audience is allowed to have enough time to read the second interaction message; and on the other hand, the overall displaying effect of the live-streaming page at the audience client is not affected as the second interaction message is prevented from being always shown at the preset position.

In some embodiments, displaying the second interaction message on the live-streaming page includes: acquiring a third interaction message by aggregating a plurality of second interaction messages in response to receiving the plurality of second interaction messages; and displaying the third interaction message on the live-streaming page.

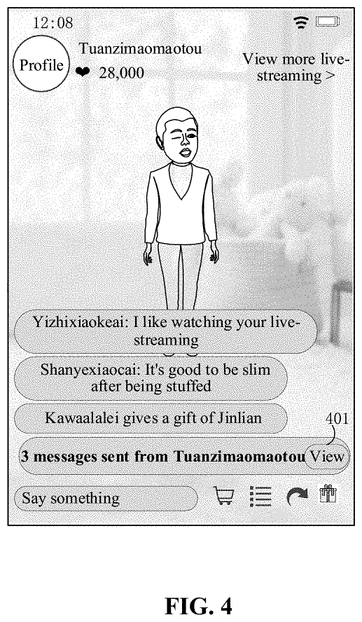

In some embodiments, when the first message processing client processes the first interaction message, a plurality of second interaction messages may be continuously sent to the audience client within a preset time period (for example, within 10 seconds). After the audience client receives the plurality of second interaction messages as continuously sent, the third interaction message is formed by aggregating the plurality of second interaction messages. FIG. 4 exemplarily shows a schematic diagram of a third interaction message displayed by the audience client. As shown in FIG. 4, the third interaction message 401 is acquired by aggregating three continuously received second interaction messages.

According to the embodiments of the present disclosure, by aggregately displaying the interaction messages as continuously received, on the one hand, it is convenient for the audience to acquire the context information of the plurality of interaction messages as continuously sent; and on the other hand, the displaying effect of the live-streaming page at the audience client is not affected as the aggregated message occupies less displaying space and a displaying space for the interaction messages on the live-streaming page can be saved.

In some embodiments, the second interaction message is acquired after the first message processing client processes the first interaction message. Here, the first message processing client serves as an auxiliary client corresponding to the anchor client, and is configured to directly reply to the first interaction message sent from the audience client. The first message processing client and the anchor client are associated by means of the same account or different accounts.

In some embodiments, after the first message processing client receives the first interaction message sent from the audience client, the first interaction message is displayed on a message processing page. The message processing person triggers a reply operation (for example, clicking a reply control displayed on the message processing page) for the first interaction message, and then inputs the second interaction message. The first message processing client acquires the second interaction message; the first message processing client sends the second interaction message to the audience client by the server in response to receiving the message sending instruction.

Continuing to refer to FIG. 3, FIG. 3 exemplarily shows a schematic diagram of a second interaction message from the first message processing client. As shown in FIG. 3, the first message processing client and the anchor client are associated by the same account. The second interaction message is displayed at the bottom of other messages according to a preset format and a preset message displaying style. The preset format is “An alias of an anchor account: @An alias of an audience account at an audience client, and a reply from the message processing person.”

According to the embodiments of the present disclosure, by providing the first message processing client, the first message processing client can focus on processing the interaction messages of the audience, such that the audience messages can be processed in time, and the processing efficiency of the audience messages is improved, thereby facilitating the improvement of an interactive effect in the live-streaming room, and help lengthening the time of the audience in watching live-streaming.

In some embodiments, the second interaction message is acquired by processing the first interaction message by the second message processing client, and the first interaction message is forwarded by the first message processing client to the second message processing client. The second message processing client is also called a third-party message processing client.

Here, the second message processing client is another client associated with the first message processing client. For example, if the current live-streaming is e-commerce live-streaming, the second message processing client is an e-commerce customer service client. The first message processing client forwards the first interaction message to the second message processing client, and the second message processing client replies to the first interaction message to acquire/generate the second interaction message.

In some embodiments, the first message processing client is provided with a message forwarding control. In response to a trigger operation on the message forwarding control, the first message processing client sends a message processing request to the second message processing client, wherein the message processing request carries the first interaction message. After receiving the message processing request, the second message processing client displays the first interaction message on a message processing page. The second interaction message is generated by replying to the first interaction message by the message processing page, and the second interaction message is sent to the audience client by the server.

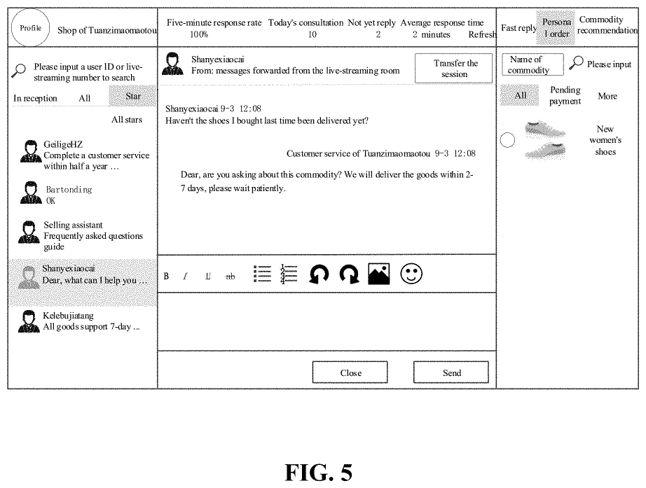

FIG. 5 exemplarily shows a message processing page displayed by a second message processing client. As shown in FIG. 5, the second message processing client updates the first interaction message to a session corresponding to the audience client. A third-party person inputs the second interaction message by the message processing page. After the third-party person clicks a sending control, the second message processing client receives a sending instruction, and the second interaction message is sent to the audience client by the server.

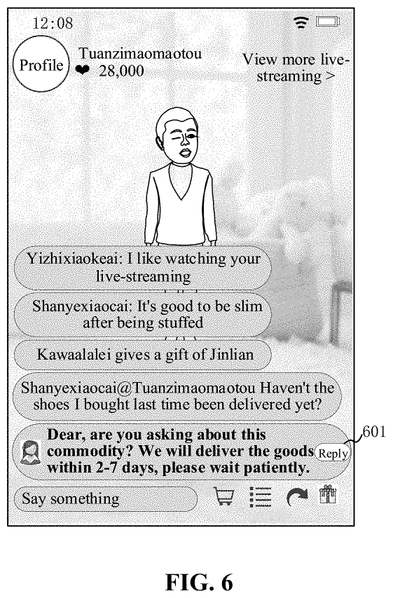

FIG. 6 exemplarily shows the second interaction message sent by the second message processing client and displayed at the audience client. As shown in FIG. 6, the audience client displays the second interaction message 601 at a preset position on the live-streaming page according to the first message displaying style.

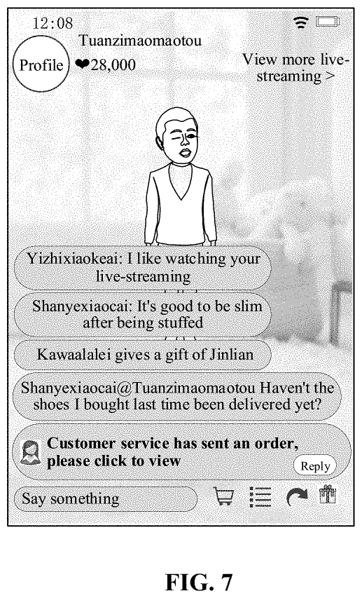

In some embodiments, referring to FIG. 7, the second interaction message is an associated link, for example, an order link.

According to the embodiments of the present disclosure, the first message processing client can access the associated second message processing client, and directly participates in processing the first interaction message by means of the second message processing client, such that the audience messages can be responded to timely and accurately, thereby reducing the processing time among the audience, the message processing person and the third-party person, and improving the message processing efficiency.

In some embodiments, the method further includes: displaying a first message reply control on the live-streaming page; and displaying a first session page in response to a trigger operation on the first message reply control, wherein the first session page is configured to display an interaction session that the audience client participates in. For example, the first session page is configured to realize an interaction session between the audience client and the second message processing client.

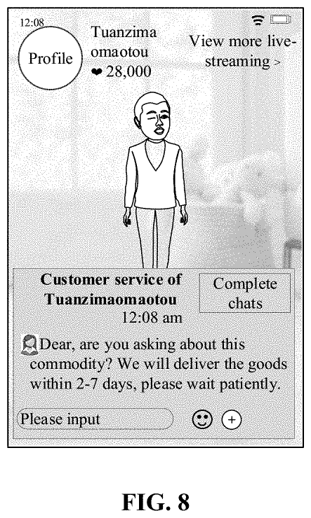

In some embodiments, the audience client displays the first message reply control while displaying the second interaction message (referring to FIG. 6). The first session page is displayed at the audience client in response to the audience triggering the first message reply control, such that the audience can directly communicate with the third-party person while watching the live-streaming. The session page is displayed in a preset size at the preset position on the live-streaming page in a form of, for example, a pop-up window, a full screen, a half screen, etc. FIG. 8 exemplarily shows a schematic diagram of a session page. As shown in FIG. 8, the session page is displayed in a form of a half screen.

In some embodiments, for the second interaction message from the first message processing client, the second message reply control is also displayed on the live-streaming interface. In response to a trigger operation on the second message reply control, the second session interface is displayed and is configured to realize an interaction session between the audience client and the first message processing client.

According to the embodiments of the present disclosure, by providing the session page for the direct session between the audience client and the second message processing client, the message processing time between the audience and third-party person can be shortened, such that the message processing efficiency can be improved.

In some embodiments, the method further includes: displaying a first session record control on the session page; and displaying a first history session record in response to a trigger operation on the first session record control, wherein the first history session record includes a history interaction session participated by the audience client. For example, the first history session record includes an interaction session between the audience client and the first message processing client.

In some embodiments, the first session record control is displayed on the session page, and refers to a “complete chats” control in FIG. 8.

In some embodiments, for the second interaction message from the first message processing client, a second session record control is displayed on the session page; and in response to a trigger operation on the first session record control, a second history session record is displayed, wherein the second history session record includes a history interaction session participated by the audience client. For example, the second history session record includes an history interaction session between the audience client and the first message processing client.

According to the embodiments of the present disclosure, by deploying the session record controls, the audience can acquire the history session record while watching the live-streaming, such that the convenience of the audience is improved.

In some embodiments, the first interaction message and the second interaction message are private chat messages.

In some embodiments, if the first interaction message is sent when the message interaction control is in the activated state, the server unidirectionally sends the first interaction message to the first message processing client. After receiving the second interaction message sent from the first message processing client or the second message processing client, the second interaction message is unidirectionally sent to the audience client.

In some embodiments, the server further sends the first interaction message and the second interaction message to the anchor client, such that the anchor can know message interaction in real time.

According to the embodiments of the present disclosure, by transmitting the first interaction message and the second interaction message in the form of the private chat messages, the audience messages can be processed in time without affecting other audiences, and meanwhile, the privacy of the audience messages is protected.

In some embodiments, receiving the second interaction message includes: receiving the second interaction message sent from a server, wherein the server is configured to push the second interaction message to the audience client in a case that the audience client is in an online state and account information corresponding to the audience client is not present in the live-streaming room. The server is further configured to push the second interaction message to a terminal corresponding to the audience client in the case that the audience client is in an offline state. Here, the server determines that the account information is not present in the live-streaming room in the case that the account information is not in a list of audiences who are watching the live-streaming.

In some embodiments, in response to the message sending instruction, the first message processing client or the second message processing client sends the second interaction message to the server. The server acquires the current client state of the audience client. In the case that the audience client is in the online state and the account information corresponding to the audience client is not present in the live-streaming room, the second interaction message is pushed to the audience client. In the case that the audience client is in the offline state, the second interaction message is pushed to the terminal corresponding to the audience client, and is pushed to, for example, a lock screen notification or a notification bar of the terminal.

According to the embodiments of the present disclosure, by enabling the server to push the second interaction message differently based on the client state of the audience client, the audience can read the second interaction message at the first time, such that the message processing efficiency can be accelerated.

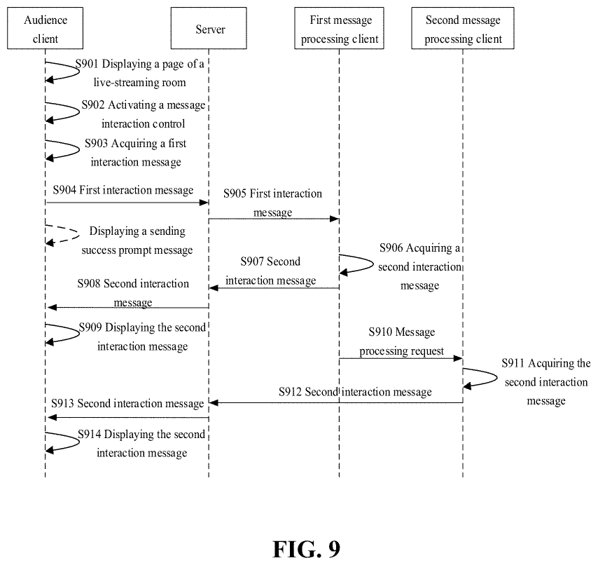

FIG. 9 is a flowchart of a method for message interaction according to some embodiments. As shown in FIG. 9, the method for message interaction is applicable to a system including an audience client, a server, a first message processing client and a second message processing client, and includes the following steps.

In S901, the audience client displays a live-streaming page of a live-streaming room, wherein a message interaction control is displayed on the live-streaming page, is in an inactivated state, and is configured to perform message interaction with a first message processing client which is an auxiliary client corresponding to an anchor client.

In S902, the audience client changes the message interaction control from the inactivated state to an activated state in response to a trigger operation on the message interaction control.

In S903, the audience client acquires a first interaction message as input in response to the message interaction control being in the activated state.

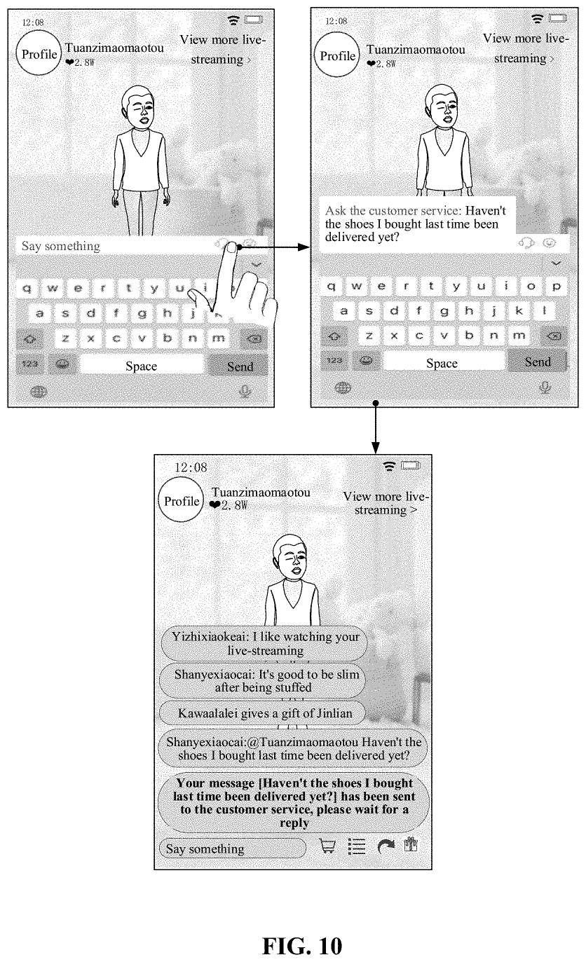

As shown in FIG. 10, the message interaction control is displayed in a message input box, and its initial state is the inactivated state. The audience client changes the state of the message interaction control to the activated state after audience clicks the message interaction control. In some embodiments, as shown in FIG. 10, after the message interaction control is activated, a text “Ask a customer service” automatically appears in the message input box. The audience inputs the content of the interaction message, such as “Haven't the shoes I bought last time been delivered yet?” in the message input box.

In some embodiments, after the audience clicks the message interaction control again, the audience client changes the state of the message interaction control to the inactivated state, and cancels the text “Ask a customer service.”

In S904, the audience client sends the first interaction message to the server in response to the message sending instruction on the first interaction message.

In S905, the server sends the first interaction message to the first message processing client.

As shown in FIG. 10, after the first interaction message is sent to the first message processing client, the audience client displays a prompt message, such as “Your message [Haven't the shoes I bought last time been delivered yet?] has been sent to the customer service, please wait for a reply” on the live-streaming page to remind the audience that the first interaction message has been sent successfully.

In S906, after receiving the first interaction message, the first message processing client replies to or forwards the first interaction message. In a case that the first message processing client replies to the first interaction message, the second interaction message is acquired.

In S907, the first message processing client sends the second interaction message to the server.

In S908, the server sends the second interaction message to the audience client.

In S909, the audience client displays the second interaction message.

Referring to FIG. 3, the second interaction message replied by the first message processing client is fixedly displayed at the bottom of the live-streaming page in a displaying style different from those of other messages, and the display of the second interaction message is cancelled after the displaying duration reaches a preset duration.

In S910, a message processing request is sent to the second message processing client in a case that the first message processing client forwards the first interaction message, wherein the message processing request carries the first interaction message.

In S911, referring to FIG. 5, the second message processing client acquires a second interaction message by replying to the first interaction message.

In S912, the second message processing client sends the second interaction message to the server.

In S913, the server sends the second interaction message to the audience client.

In S914, the audience client displays the second interaction message.

Referring to FIG. 6, the second interaction message replied by the second message processing client is fixedly displayed at the bottom of the live-streaming page in a displaying style different from those of other messages, and the display of the second interaction message is canceled after the displaying duration reaches a preset duration.

In some embodiments, referring to FIG. 4, in the case of continuously receiving a plurality of second interaction messages sent from the first message processing client or the second message processing client, the audience client acquires a third interaction message by aggregating the plurality of second interaction messages, and displays the third interaction message on the live-streaming page.

In some embodiments, referring to FIG. 8, the audience client displays a session page in response to a trigger operation on a message reply control, such that the audience client and the second message processing client can directly realize a session by means of the session page.

It should be understood that although the various steps in the above flowchart are sequentially displayed as indicated by the arrows, these steps are not necessarily performed in the order indicated by the arrows. Except as explicitly stated herein, the execution of these steps is not strictly limited, and can be performed in other sequences. Moreover, at least some of the steps in the above flowchart include a plurality of sub-steps or stages, which are not necessarily performed at the same time, but are executed at different time. The execution order of the steps is also not necessarily performed sequentially, but these steps are performed in turn or alternately with at least part of other steps or sub-steps or stages of other steps.

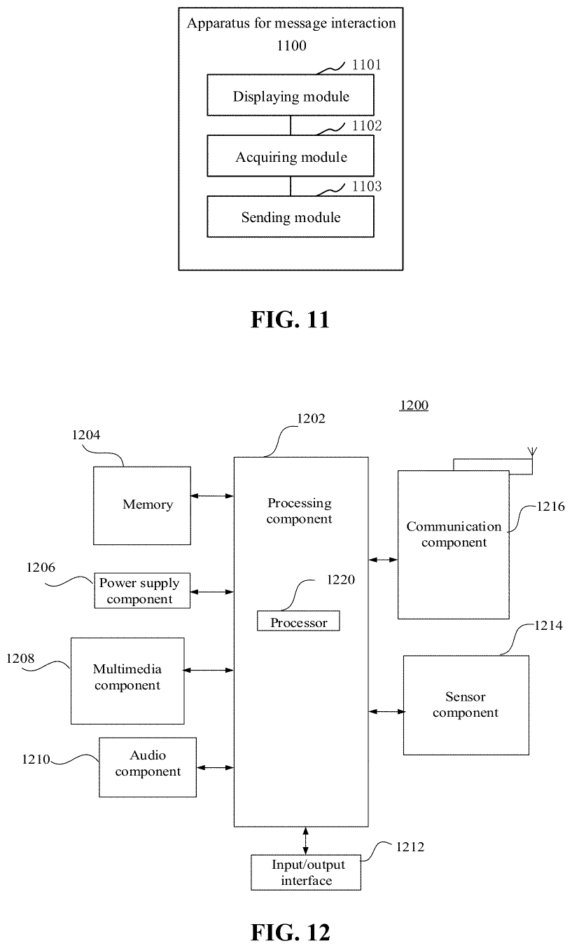

FIG. 11 is a block diagram of an apparatus 1100 for message interaction according to some embodiments. Referring to FIG. 11, the apparatus includes a displaying module 1101, an acquiring module 1102, and a sending module 1103.

The displaying module 1101 is configured to display a live-streaming page of a live-streaming room, wherein a message interaction control is displayed on the live-streaming page, the message interaction control being configured to perform message interaction with a first message processing client, the first message processing client being an auxiliary client corresponding to an anchor client. The acquiring module 1102 is configured to acquire a first interaction message as input in response to the message interaction control being in an activated state. The sending module 1103 is configured to send the first interaction message to the first message processing client in response to a message sending instruction on the first interaction message, wherein the first message processing client is configured to process the first interaction message.

In some embodiments, the apparatus 1100 further includes: an updating module configured to change the message interaction control from an inactivated state to the activated state in response to a trigger operation on the message interaction control.

In some embodiments, the apparatus 1100 further includes: a receiving module configured to receive a second interaction message acquired by processing the first interaction message by the first message processing client. The displaying module 1101 is further configured to display the second interaction message on the live-streaming page.

In some embodiments, the displaying module 1101 is configured to display the second interaction message on the live-streaming page according to a first message displaying style, wherein the first message displaying style is different from a second message displaying style, the second message displaying style corresponding to an interaction message at the live-streaming client.

In some embodiments, the displaying module 1101 is further configured to display the second interaction message at a preset position on the live-streaming page, wherein a displaying duration of the second interaction message is a preset duration.

In some embodiments, the displaying module 1101 includes: an aggregating unit configured to aggregate a plurality of second interaction messages to acquire a third interaction message in response to receiving the plurality of second interaction messages; and a displaying unit configured to display the third interaction message on the live-streaming page.

In some embodiments, the second interaction message is acquired by processing the first interaction message by the second message processing client, and the first interaction message is forwarded by the first message processing client to the second message processing client.

In some embodiments, the displaying module 1101 is further configured to display a message reply control on the live-streaming page, and display a session page in response to a trigger operation on the message reply control, wherein the session page is configured to display an interaction session that the audience client participates in.

In some embodiments, the displaying module 1101 is further configured to display a session page in a preset size at a preset position on the live-streaming page.

In some embodiments, the displaying module 1101 is further configured to display a session record control on the session page, and display a history session record in response to a trigger operation on the session record control, wherein the history session record includes a history interaction session participated by the audience client.

In some embodiments, the receiving module is configured to receive the second interaction message sent from the server, wherein the server is configured to push the second interaction message to the audience client in response to the audience client being in an online state and account information corresponding to the audience client being not present in the live-streaming room; and the server is further configured to push the second interaction message to a terminal corresponding to the audience client in response to the audience client being in an offline state.

With respect to the apparatus in the above embodiments, the specific ways for individual modules in the apparatus to perform operations have been described in detail in the embodiments of the related methods, and are not elaborated herein.

FIG. 12 is an internal structure diagram of a terminal 1200 for message interaction according to some embodiments. For example, the terminal 1200 is a mobile phone, a computer, a digital broadcast terminal, a messaging device, a game console, a tablet device, a medical device, a fitness device, a personal digital assistant, and the like.

Referring to FIG. 12, the terminal 1200 includes one or more following components: a processing component 1202, a memory 1204, a power supply component 1206, a multimedia component 1208, an audio component 1210, an input/output (I/O) interface 1212, a sensor component 1214, and a communication component 1216.

The processing component 1202 typically controls overall operations of the terminal 1200, such as the operations associated with display, telephone calls, data communications, camera operations, and record operations. The processing component 1202 may include one or more processors 1220 to execute instructions to realize all or part of the steps in the above-described methods. Moreover, the processing component 1202 includes one or more modules that facilitate the interaction between the processing component 1202 and other components. For example, the processing component 1202 includes a multimedia module to facilitate the interaction between the multimedia component 1208 and the processing component 1202.

The memory 1204 is configured to store various types of data to support the operations on the terminal 1200. Examples of such data include instructions for any applications or methods operated on the terminal 1200, contact data, phonebook data, messages, pictures, videos, etc. The memory 1204 is implemented by using any type of transitory or non-transitory memory device, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1206 provides power to various components of the terminal 1200. The power supply component 1206 includes a power supply management system, one or more power supplies, and any other components associated with the generation, management, and distribution of power of the terminal 1200.

The multimedia component 1208 includes a screen providing an output interface between the terminal 1200 and a user. In some embodiments, the screen includes a liquid crystal display (LCD) and a touch panel (TP). If the screen includes the touch panel, the screen is implemented as a touch screen to receive input signals from the user. The touch panel includes one or more touch sensors to sense touches, swipes and gestures on the touch panel. The touch sensors not only sense a boundary of a touch or swipe action, but also detect a period of time and a pressure associated with the touch or swipe action. In some embodiments, the multimedia component 1208 includes a front camera and/or a rear camera. The front camera and/or the rear camera receive/receives an external multimedia datum while the terminal 1200 is in an operation mode, such as a photographing mode or a video mode. Each of the front and rear cameras is a fixed optical lens system or has a focus and optical zoom capability.

The audio component 1210 is configured to output and/or input audio signals. For example, the audio component 1210 includes a microphone (MIC) configured to receive an external audio signal when the terminal 1200 is in an operation mode, such as a call mode, a record mode, and a voice recognition mode. The received audio signal is further stored in the memory 1204 or transmitted via the communication component 1216. In some embodiments, the audio component 1210 further includes a speaker configured to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide the terminal 1200 with state assessments of various aspects. For instance, the sensor component 1214 detects an open/closed state of the terminal 1200, relative positioning of components, e.g., a display and a keypad, of the terminal 1200, a change in position of the terminal 1200 or a component of the terminal 1200, a presence or absence of user's contact with the terminal 1200, an orientation or an acceleration/deceleration of the terminal 1200, and a change in temperature of the terminal 1200. The sensor component 1214 further includes a proximity sensor configured to detect the presence of nearby objects without any physical contact. The sensor component 1214 further includes a light sensor, such as a CMOS or CCD image sensor, for use in imaging applications. In some embodiments, the sensor component 1214 further includes an accelerometer sensor, a gyroscope sensor, a magnetic sensor, a pressure sensor or a temperature sensor.

The communication component 1216 is configured to facilitate wired or wireless communication between the terminal 1200 and other devices. The terminal 1200 accesses a wireless network based on a communication standard, such as WiFi, an operator network (such as 2G, 3G, 4G or 5G), or a combination thereof. In some embodiments, the communication component 1216 receives a broadcast signal or broadcast associated information from an external broadcast management system over a broadcast channel. In some embodiments, the communication component 1216 further includes a near field communication (NFC) module to facilitate short-range communications. For example, the NFC module may be implemented based on the radio frequency identification (RFID) technology, infrared data association (IrDA) technology, ultra-wideband (UWB) technology, Bluetooth (BT) technology, and other technologies.

In some embodiments, the terminal 1200 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In some embodiments, a terminal is also provided. The terminal includes a processor; and

a memory configured to store at least one instruction executable by the processor,

wherein processor, when loading and executing the at least one instruction, is caused to perform:

displaying a live-streaming page of a live-streaming room, wherein a message interaction control is displayed on the live-streaming page, the message interaction control being configured to perform message interaction with a first message processing client, the first message processing unit being an auxiliary client corresponding to an anchor client;

acquiring a first interaction message as input in response to the message interaction control being in an activated state; and

sending the first interaction message to the first message processing client in response to a message sending instruction on the first interaction message, wherein the first message processing client is configured to process the first interaction message.

In some embodiments, the processor, when loading and executing the at least one instruction, is further caused to perform:

changing the message interaction control from an inactivated state to the activated state in response to a trigger operation on the message interaction control.

In some embodiments, the processor, when loading and executing the at least one instruction, is further caused to perform:

receiving a second interaction message, wherein the second interaction message is acquired by processing the first interaction message by the first message processing client; and

displaying the second interaction message on the live-streaming page.

In some embodiments, the processor, when loading and executing the at least one instruction, is further caused to perform:

displaying the second interaction message on the live-streaming page according to a first message displaying style, wherein the first message displaying style is different from a second message displaying style, the second message displaying style corresponding to an interaction message at the live-streaming client.

In some embodiments, the processor, when loading and executing the at least one instruction, is further caused to perform:

displaying the second interaction message at a preset position on the live-streaming page, wherein a displaying duration of the second interaction message is a preset duration.

In some embodiments, the processor, when loading and executing the at least one instruction, is further caused to perform:

acquiring a third interaction message by aggregating a plurality of second interaction messages in response to receiving the plurality of second interaction messages; and

displaying the third interaction message on the live-streaming page.

In some embodiments, the second interaction message is acquired by processing the first interaction message by a second message processing client, and the first interaction message is forwarded by the first message processing client to the second message processing client.

In some embodiments, the processor, when loading and executing the at least one instruction, is further caused to perform:

further displaying a message reply control on the live-streaming page; and displaying a session page in response to a trigger operation on the message reply control, wherein the session page is configured to display an interaction session that the audience client participates in.

In some embodiments, the processor, when loading and executing the at least one instruction, is further caused to perform:

displaying a session page in a preset size at a preset position on the live-streaming page.

In some embodiments, the processor, when loading and executing the at least one instruction, is further caused to perform:

displaying a session record control on the session page; and displaying a history session record in response to a trigger operation on the session record control, wherein the history session record includes a history interaction session participated by the audience client.

In some embodiments, the processor, when loading and executing the at least one instruction, is further caused to perform:

receiving the second interaction message sent from a server, wherein

the server is configured to push the second interaction message to the audience client in response to the audience client being in an online state and account information corresponding to the audience client being not present in the live-streaming room; and

the server is further configured to push the second interaction message to a terminal corresponding to the audience client in response to the audience client being in an offline state.

In some embodiments, a non-transitory storage medium is further provided, such as a memory 1204 storing at least one instruction therein, wherein the at least one instruction, when loaded and executed by a processor 1220 of a terminal 1200, causes the terminal 1200 to perform the above method. For example, the non-transitory computer-readable storage medium is an ROM, a random access storage (RAM), a CD-ROM, a magnetic tape, a floppy disc, an optical data storage device, and the like.

The present disclosure provides a method and an apparatus for message interaction, an electronic device and a storage medium to at least solve a problem that the processing efficiency of audience messages is lower as some important messages are easily overlooked and missed by an anchor in the related art. The technical solutions of the present disclosure are as follows:

According to a first aspect of embodiments of the present disclosure, a method for message interaction is provided. The method is applicable to an audience client, and includes:

displaying a live-streaming page of a live-streaming room, wherein a message interaction control is displayed on the live-streaming page; acquiring a first interaction message in response to the message interaction control being in an activated state; and sending the first interaction message to a message processing client corresponding to the live-streaming room in response to a message sending instruction on the first interaction message, wherein the message processing client is configured to process the first interaction message.

In some embodiments, in a case that the message interaction control is in the activated state, prior to acquiring the first interaction message, the method further includes: changing the message interaction control from the inactivated state to the activated state in response to a trigger operation on the message interaction control.

In some embodiments, after the first interaction message is sent to the message processing client corresponding to the live-streaming room, the method further includes: receiving a second interaction message acquired by processing the first interaction message; and displaying the second interaction message on the live-streaming page.

In some embodiments, said displaying the second interaction message on the live-streaming page includes: acquiring a preset message displaying style of the second interaction message; rendering the second interaction message based on the message displaying style; and displaying the rendered second interaction message on the live-streaming page.

In some embodiments, said displaying the second interaction message on the live-streaming page includes: displaying the second interaction message at a preset position on the live-streaming page, wherein a displaying duration of the second interaction message at the preset position reaches a preset duration.

In some embodiments, said displaying the second interaction message on the live-streaming page includes: acquiring the second interaction message by aggregating a plurality of interaction messages acquired by processing the first interaction message by the message processing client; and displaying the second interaction message on the live-streaming page.

In some embodiments, the second interaction message is an interaction message generated after the message processing client processes the first interaction message.

In some embodiments, the second interaction message is an interaction message generated after a third-party message processing client processes the first interaction message which is forwarded to the third-party message processing client by the message processing client.

In some embodiments, the method further includes: displaying a message reply control on the live-streaming page; and displaying a session page in response to a trigger operation on the message reply control, wherein the session page is configured to realize an interaction session between the audience client and the third-party message processing client.

In some embodiments, said displaying the session page in response to a trigger operation on the message reply control includes: displaying the session page in a preset size at a preset position on the live-streaming page in response to the trigger operation on the message reply control.

In some embodiments, the method further includes: displaying a session record control on the session page; and displaying a history session record between the audience client and the third-party message processing client in response to a trigger operation on the session record control.

In some embodiments, the first interaction message and the second interaction message are private chat messages.

In some embodiments, said receiving the second interaction message generated after the first interaction message is processed includes: receiving the second interaction message which is generated after the first interaction message is processed and which is sent from the server, wherein the server is configured to push the second interaction message to the audience client in a case that the acquired audience client is in an online state and account information corresponding to the audience client is not present in a list of the audience who are watching the live-streaming, and push the second interaction message to a terminal corresponding to the audience client in a case that the audience client is in an offline state.

According to a second aspect of the embodiments of the present disclosure, an apparatus for message interaction is provided. The apparatus is applicable to an audience client, and includes:

a displaying module configured to display a live-streaming page of a live-streaming room, wherein a message interaction control is displayed on the live-streaming page; an acquiring module configured to acquire a first interaction message in response to the message interaction control being in an activated state; and a sending module configured to send the first interaction message to a message processing client corresponding to the live-streaming room in response to a message sending instruction on the first interaction message, wherein the message processing client is configured to process the first interaction message.

In some embodiments, the apparatus further includes: an updating module configured to change the message interaction control from an inactivated state to the activated state in response to a trigger operation on the message interaction control.

In some embodiments, the apparatus further includes: a receiving module configured to receive a second interaction message acquired by processing the first interaction message, wherein the displaying module is further configured to display the second interaction message on the live-streaming page.

In some embodiments, the displaying module includes: an acquiring unit configured to acquire a preset message displaying style of the second interaction message; and a rendering unit configured to render the second interaction message according to the message displaying style; and a first displaying unit configured to display the rendered second interaction message on the live-streaming page.

In some embodiments, the displaying module is further configured to display the second interaction message at a preset position on the live-streaming page, wherein a displaying duration of the second interaction message at the preset position reaches a preset duration.

In some embodiments, the displaying module includes: an aggregating unit configured to aggregate a plurality of interaction messages acquired by processing the first interaction message by the message processing client to acquire the second interaction message; and a second displaying unit configured to display the second interaction message on the live-streaming page.

In some embodiments, the second interaction message is an interaction message generated after the message processing client processes the first interaction message.

In some embodiments, the second interaction message is an interaction message generated after a third-party message processing client processes the first interaction message which is forwarded to the third-party message processing client by the message processing client.

In some embodiments, the displaying module is further configured to display a message reply control on the live-streaming page, and display a session page in response to a trigger operation on the message reply control, wherein the session page is configured to realize an interaction session between the audience client and the third-party message processing client.

In some embodiments, the displaying module is further configured to display the session page in a preset size at a preset position on the live-streaming page in response to the trigger operation on the message reply control.

In some embodiments, the displaying module is further configured to display a session record control on the session page, and display a history session record between the audience client and the third-party message processing client in response to a trigger operation on the session record control.

In some embodiments, the first interaction message and the second interaction message are private chat messages.

In some embodiments, the receiving module is configured to receive the second interaction message which is generated after the first interaction message is processed and which is sent from the server, wherein the server is configured to push the second interaction message to the audience client in a case that the acquired audience client is in an online state and account information corresponding to the audience client is not present in a list of the audience who are watching the live-streaming, and push the second interaction message to a terminal corresponding to the audience client in the case that the audience client is in an offline state.

According to a third aspect of the embodiments of the present disclosure, an electronic device is provided. The electronic device includes:

a processor; and a memory configured to store at least one instruction executable by the processor,

wherein the processor, when loading and executing the at least one instruction, is caused to perform the method for message interaction according to any one of the embodiments in the first aspect.

According to a fourth aspect of the embodiments of the present disclosure, a storage medium storing at least one instruction therein is provided, wherein the at least one instruction, when loaded and executed by a processor of an electronic device, causes the electronic device to perform the method for message interaction according to any one of the embodiments in the first aspect.

According to a fifth aspect of the embodiments of the present disclosure, a computer program product including a computer program stored in a readable storage medium is provided, wherein the computer program, when read and executed by at least one processor of a device from the readable storage medium, causes the device to perform the method for message interaction according to any one of the embodiments in the first aspect.

The technical solutions according to the embodiments of the present disclosure achieve at least the following beneficial effects.

The live-streaming page of the live-streaming room is displayed when the audience watches the live-streaming video of the anchor, wherein the message interaction control is displayed on the live-streaming page; the first interaction message is acquired in a case that the message interaction control is in the activated state; and the first interaction message is sent to the message processing client corresponding to the live-streaming room in response to the message sending instruction on the first interaction message, wherein the message processing client is configured to process the first interaction message. By providing the message interaction control, on the one hand, the audience can send the messages that require responses to the message processing client capable of process the messages in time, such that audience messages can be processed in time, thereby improving the processing efficiency of the audience messages, facilitating the improvement of an interaction effect in the live-streaming room, and lengthening the time of the audience in watching live-streaming.

All the embodiments of the present disclosure can be executed individually or in combination with other embodiments, which are all regarded as being included in the scope of protection claimed by the present disclosure.

What is claimed is:

1. A method for message interaction, applicable to an audience client, the method comprising:
displaying a live-streaming page of a live-streaming room, wherein a message interaction control is displayed on the live-streaming page, the message interaction control being configured to perform message interaction with a first message processing client, and the first message processing client being an auxiliary client corresponding to an anchor client;
acquiring a first interaction message as input in response to the message interaction control being in an activated state; and
sending the first interaction message to the first message processing client in response to a message sending instruction on the first interaction message, wherein the first message processing client is configured to process the first interaction message.

2. The method according to claim 1, further comprising:
changing the message interaction control from an inactivated state to the activated state in response to a trigger operation on the message interaction control.

3. The method according to claim 1, further comprising:
receiving a second interaction message, wherein the second interaction message is acquired by processing the first interaction message by the first message processing client; and
displaying the second interaction message on the live-streaming page.

4. The method according to claim 3, wherein said displaying the second interaction message on the live-streaming page comprises:
displaying the second interaction message on the live-streaming page according to a first message displaying style, wherein the first message displaying style is different from a second message displaying style, the second message displaying style corresponding to an interaction message at the live-streaming page.

5. The method according to claim 3, wherein said displaying the second interaction message on the live-streaming page comprises:
displaying the second interaction message at a preset position on the live-streaming page, until a displaying duration of the second interaction message reaches a preset duration.

6. The method according to claim 3, wherein said displaying the second interaction message on the live-streaming page comprises:
acquiring a third interaction message by aggregating a plurality of second interaction messages in response to receiving the plurality of second interaction messages; and
displaying the third interaction message on the live-streaming page.

7. The method according to claim 3, wherein the second interaction message is acquired by processing the first interaction message by a second message processing client, and the first interaction message is forwarded by the first message processing client to the second message processing client.

8. The method according to claim 1, further comprising:
further displaying a message reply control on the live-streaming page; and
displaying a session page in response to a trigger operation on the message reply control, wherein the session page is configured to display an interaction session that the audience client participates in.

9. The method according to claim 8, wherein said displaying the session page comprises:
displaying the session page in a preset size at a preset position on the live-streaming page.

10. The method according to claim 8, further comprising:
displaying a session record control on the session page; and
displaying a history session record in response to a trigger operation on the session record control, wherein the history session record comprises a history interaction session participated by the audience client.

11. The method according to claim 3, wherein said receiving the second interaction message comprises:
receiving the second interaction message sent from a server, wherein
the server is configured to push the second interaction message to the audience client in response to the audience client being in an online state and account information corresponding to the audience client being not present in the live-streaming room; and
the server is further configured to push the second interaction message to a terminal corresponding to the audience client in response to the audience client being in an offline state.

12. A terminal of an audience client, comprising:
a processor; and
a memory configured to store at least one instruction executable by the processor;
wherein the processor, when loading and executing the at least one instruction, is caused to perform:
displaying a live-streaming page of a live-streaming room, wherein a message interaction control is displayed on the live-streaming page, the message interaction control being configured to perform message interaction with a first message processing client, and the first message processing client being an auxiliary client corresponding to an anchor client;
acquiring a first interaction message as input in response to the message interaction control being in an activated state; and
sending the first interaction message to the first message processing client in response to a message sending instruction on the first interaction message, wherein the first message processing client is configured to process the first interaction message.

13. The terminal according to claim 12, wherein the processor, when loading and executing the at least one instruction, is further caused to perform:
changing the message interaction control from an inactivated state to the activated state in response to a trigger operation on the message interaction control.

14. The terminal according to claim 12, wherein the processor, when loading and executing the at least one instruction, is further caused to perform:
receiving a second interaction message, wherein the second interaction message is acquired by processing the first interaction message by the first message processing client; and
displaying the second interaction message on the live-streaming page.

15. The terminal according to claim 14, wherein the processor, when loading and executing the at least one instruction, is further caused to perform:
displaying the second interaction message on the live-streaming page according to a first message displaying style, wherein the first message displaying style is different from a second message displaying style, the second message displaying style corresponding to an interaction message at the live-streaming page.

16. The terminal according to claim 14, wherein the processor, when loading and executing the at least one instruction, is further caused to perform:
acquiring a third interaction message by aggregating a plurality of second interaction messages in response to receiving the plurality of second interaction messages; and
displaying the third interaction message on the live-streaming page.

17. The terminal according to claim 14, wherein the second interaction message is acquired by processing the first interaction message by a second message processing client, and the first interaction message is forwarded by the first message processing client to the second message processing client.

18. The terminal according to claim 12, wherein the processor, when loading and executing the at least one instruction, is further caused to perform:
further displaying a message reply control on the live-streaming page; and
displaying a session page in response to a trigger operation on the message reply control, wherein the session page is configured to display an interaction session that the audience client participates in.

19. The terminal according to claim 17, wherein the processor, when loading and executing the at least one instruction, is further caused to perform:
displaying a session record control on the session page; and
displaying a history session record in response to a trigger operation on the session record control, wherein the history session record comprises a history interaction session participated by the audience client.

20. A non-transitory storage medium storing at least one instruction therein, wherein the at least one instruction, when loaded and executed by a processor of a terminal, causes the terminal to perform:
displaying a live-streaming page of a live-streaming room, wherein a message interaction control is displayed on the live-streaming page, the message interaction control being configured to perform message interaction with a first message processing client, and the first message processing client being an auxiliary client corresponding to an anchor client;
acquiring a first interaction message as input in response to the message interaction control being in an activated state; and
sending the first interaction message to the first message processing client in response to a message sending instruction on the first interaction message, wherein the first message processing client is configured to process the first interaction message.
